(19) United States
(12) Patent Application Publication
(10) Pub. No.: US 2011/0206227 A1
(43) Pub. Date: Aug. 25, 2011

(54) DEVICE FOR INSERTING A PIN INTO A HEARING AID

(75) Inventors: UWE FLAIG, Feucht (DE); MARTIN SEGERUD, Erlangen (DE); SONGHUA YI, Erlangen (DE)

(73) Assignee: SIEMENS MEDICAL INSTRUMENTS PTE. LTD., SINGAPORE (SG)

(21) Appl. No.: 13/031,796

(22) Filed: Feb. 22, 2011

(30) Foreign Application Priority Data
Feb. 24, 2010 (DE) DE102010009012.3

(51) Int. Cl. H04R 25/00

(52) U.S. Cl. 381/322

(57) ABSTRACT

A device for inserting a pin into a hearing aid has a gripper embodied in the shape of a cylinder. In an end face the gripper has an aperture by way of which a pin that is to be placed in the hearing aid is picked up. For this purpose the gripper is pressed onto the pin. After the pin has been successfully placed in the hearing aid, pressure is then applied, by squeezing with the hand for example, to the lateral surface of the gripper. This causes a size of the aperture to be changed in the radial direction, as a result of which the pin clasped by the gripper is released. By this means it is advantageously possible to pick up a pin that is to be placed in the hearing aid and install it while making use of only one hand and without recourse to a tool such as a pair of tweezers, for example.

### CROSS-REFERENCE TO RELATED APPLICATION

This application claims the priority, under 35 U.S.C. §119, of German patent application DE 10 2010 009 012.3, filed Feb. 24, 2010; the prior application is herewith incorporated by reference in its entirety.

### BACKGROUND OF THE INVENTION

### Field of the Invention

The invention relates to a device for inserting a pin into a hearing aid. The device has a cylinder-shaped gripper.

Devices for inserting pins are known inter alia in the field of hearing aid technology.

Hearing aids are wearable hearing devices that serve to provide hearing assistance to the hearing-impaired. In order to accommodate the multiplicity of individual requirements, hearing aids are provided in different designs, including behind-the-ear (BTE) hearing aids, hearing aids with external earpiece and in-the-ear (ITE) hearing aids, e.g. concha hearing aids or completely-in-the-canal (CIC) hearing aids. The hearing aids cited by way of example are worn on the outer ear or in the auditory canal. In addition, however, bone conduction hearing aids and implantable or vibrotactile hearing aids are also commercially available. With these devices the damaged hearing is stimulated either mechanically or electrically.

Basically, hearing aids have as their main components an input transducer, an amplifier and an output transducer. The input transducer is generally a sound receiver, e.g. a microphone, and/or an electromagnetic receiver, e.g. an induction coil. The output transducer is mostly realized as an electroacoustic transducer, e.g. a miniature loudspeaker, or as an electromechanical transducer, e.g. a bone conduction earpiece. The amplifier is usually integrated into a signal processing unit. This basic layout is shown in FIG. 1 with reference to the exemplary embodiment of a behind-the-ear hearing aid. A hearing aid housing 1 that is designed to be worn behind the ear has built into it one or more microphones 2 for recording the ambient sound. A signal processing unit (SPU) 3 which is also integrated into the hearing aid housing 1 processes the microphone signals and amplifies them. The output signal from the signal processing unit 3 is transmitted to a loudspeaker or earpiece 4 which outputs an acoustic signal. The sound is transmitted to the hearing aid wearer's eardrum, if necessary by way of a sound tube that is fixed in the auditory canal by means of an earmold. The hearing aid and in particular the signal processing unit 3 are supplied with power by way of a battery (BAT) 5 that is likewise integrated into the hearing aid housing 1.

In the arrangement of the components in the housing of a behind-the-ear hearing aid, use is typically made of cylinder-shaped pivots, also referred to as pins or spindles. This allows control elements, for example, to be integrated in the housing by means of said pins. In many hearing aids the housing shells and the battery door are also secured to the hearing aid by means of the pins.

Typically, the pins have dimensions of approx. 0.6 mm in diameter and a length in the range of approx. 3 mm to 8 mm. Different numbers of pins can be used in a hearing aid, depending on the model.

If a housing is about to be changed or if repair, maintenance or cleaning work needs to be carried out, the pins must be removed by a competent professional, for example an acoustician. For this purpose the acoustician makes use of a special tool which the hearing aid manufacturer normally provides as part of the package when the device is shipped. Upon completion of the work, pins are reinserted, likewise with the aid of the tool. Since the pins can get lost due to their small dimensions, the acoustician will generally make use of new pins when putting the hearing aid back together. For this reason, in the case of a change of housing for example, the manufacturer will supply a replacement parts box which, in addition to the housing shells, also contains the pins, preferably inserted individually in e.g. foam material. FIG. 2 shows such a prior art arrangement. A number of pins 8 are inserted into a foam padding 7 in the replacement parts box 6.

Grippers for inserting pins are well-known in the field of hearing aid technology. An embodiment of a gripper according to the prior art is shown in FIG. 3. The known gripper 9 is embodied as a hand tool formed with an aperture 10 in the end zone A for the purpose of receiving a pin 8. Disposed at the opposite end zone B to the aperture 10 is an ejector pin 11 which is fixedly joined to the gripper 9 and by way of which pins that are to be removed can be ejected.

A disadvantageous aspect of the prior art embodiments of the device for inserting pins is that the pin must be picked up with the fingers or with the aid of an auxiliary tool, a pair of tweezers for example, and inserted into the aperture of the tool. This requires that both hands are used. Since the diameter of the aperture is greater than the diameter of the pin, the pin is not automatically held tightly in the aperture. If the tool in whose aperture the pin is located is moved, there is the risk that the pin may fall out and possibly be lost.

### SUMMARY OF THE INVENTION

It is accordingly an object of the invention to provide a device which overcomes the above-mentioned disadvantages of the heretofore-known devices and methods of this general type and which provides for an improved device for inserting a pin into a hearing aid.

With the foregoing and other objects in view there is provided, in accordance with the invention, a device for inserting a pin into a hearing aid. The novel device comprises:
a gripper having a substantially cylindrical shape with a lateral surface and an end face;
the end face having an aperture formed therein, wherein a size of the aperture in the end face of the gripper is changed by pressure acting on the lateral surface of the gripper.

In other words, the objects of the invention are achieved by way of a device for inserting a pin into a hearing aid that has a cylinder-shaped gripper as claimed. The terms “cylinder-shaped” and “substantially cylindrical” as used herein should be understood in their broadest sense to include any substantially cylindrical, elongated polygonal, and pen-like handle devices.

The invention discloses a device for inserting a pin into a hearing aid. For this purpose use is made of a gripper which is embodied in a cylinder shape. In an end face the gripper has an aperture by means of which a pin that is to be placed in the hearing aid is picked up. For this purpose the gripper is pressed onto the pin. After the pin has been successfully placed in the hearing aid, pressure is then applied, by means of the hand for example, to the lateral surface of the gripper. This causes a change in the size of the aperture in the radial direction, as a result of which the pin clasped by the gripper is released. By this means it is advantageously possible to pick up a pin that is to be placed in the hearing aid and install it while making use of only one hand and without recourse to a tool such as a pair of tweezers, for example. Moreover, the risk of an inadvertent loss of the pin due to its falling out of the device is reduced. Finally, it is made possible for the device together with a picked-up pin to be put down temporarily, on a table for example, without the pin falling out in the process.

Furthermore, the aperture of the device can be configured as a circular cylinder shape. This advantageously facilitates the picking up of the typically likewise cylinder-shaped pins.

In a special embodiment the aperture can consist of cylindrical sections that are offset relative to one another. The pin is picked up by way of the aperture disposed directly at the front end of the device. An advantageous aspect of this is that with this embodiment the depth stop surface area for the picked-up pin is enlarged and as a result the pin is fixed in position more effectively during the insertion operation.

The end zone of the gripper can additionally have a plurality of slits. This advantageously causes the aperture to spread apart when pressure acts on the lateral surface, thereby releasing the pin clasped in the aperture.

In a further embodiment of the invention the diameter of the aperture in a first position can be smaller than the diameter of the pin. In this case the first position denotes the relaxed state of the aperture before a pin is picked up. The advantage of this is that when the device is pressed onto the pin it causes the aperture to be spread apart. The pin is held by means of the restoring force of the material of the gripper and can be moved in space in a controlled manner by way of the device.

Furthermore, the aperture can have an axis which runs parallel to the longitudinal axis of the gripper. By means of this arrangement of the aperture an optimal clasping of the pin by the device is made possible.

In a special embodiment of the invention the gripper can be formed as a single piece from an elastically deformable material and furnished with longitudinal slits along the longitudinal axis of the gripper. By this means it is achieved in an advantageous manner that a pressure applied to the lateral surface of the gripper leads to a change in the size of the aperture, resulting in the pin clasped by the gripper being released.

The end zone of the gripper with the aperture can also be embodied in a cone shape. This makes it easier to see the pin that is to be clasped by means of the aperture of the device and consequently allows the device to be utilized in a more controlled manner.

In another embodiment of the invention longitudinal slits can be disposed along the longitudinal axis of the gripper in the region of the lateral surface which is exposed to the pressure action. This enables the size of the aperture to be effectively changed by means of pressure applied to the lateral surface of the gripper.

In a development of the invention, at the opposite front end to the aperture, the gripper can include an ejector pin which is fixedly joined to the gripper and whose diameter is somewhat smaller than the diameter of the pins. Advantageously, this enables the gripper device to be used in addition to remove a pin that is integrated into the hearing aid, in that the pin is ejected by means of the ejector pin. As a result the use of an additional tool for ejecting a pin is rendered superfluous.

Other features which are considered as characteristic for the invention are set forth in the appended claims.

Although the invention is illustrated and described herein as embodied in a device for inserting a pin into a hearing aid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic diagram depicting a behind-the-ear hearing aid according to the prior art;

FIG. 2 is a perspective view of a prior art embodiment of a replacement parts box with pins inserted;

FIG. 3 is a side view of a prior art embodiment of a gripper;

FIG. 4 is a perspective view of a gripper according to the invention;

FIGS. 5A, 5B, and 5D are side views of a gripper according to the invention in a sequence during the process of picking up a pin;

FIGS. 5C is an enlarged view of a detail in FIG. 5B and FIG. 5E is an enlarged view of a detail at the tip of FIG. 5D;

FIGS. 6A, 6B, and 6D are side views of the gripper showing a sequence during the process of releasing a pin;

FIG. 6C is an enlarged view of a detail at the tip of FIG. 6B;

FIG. 7 shows a perspective view of a gripper according to the invention having a fixedly joined ejector pin; and

FIG. 8 shows a perspective view of a gripper according to the invention having an aperture consisting of cylindrical sections that are offset relative to one another.

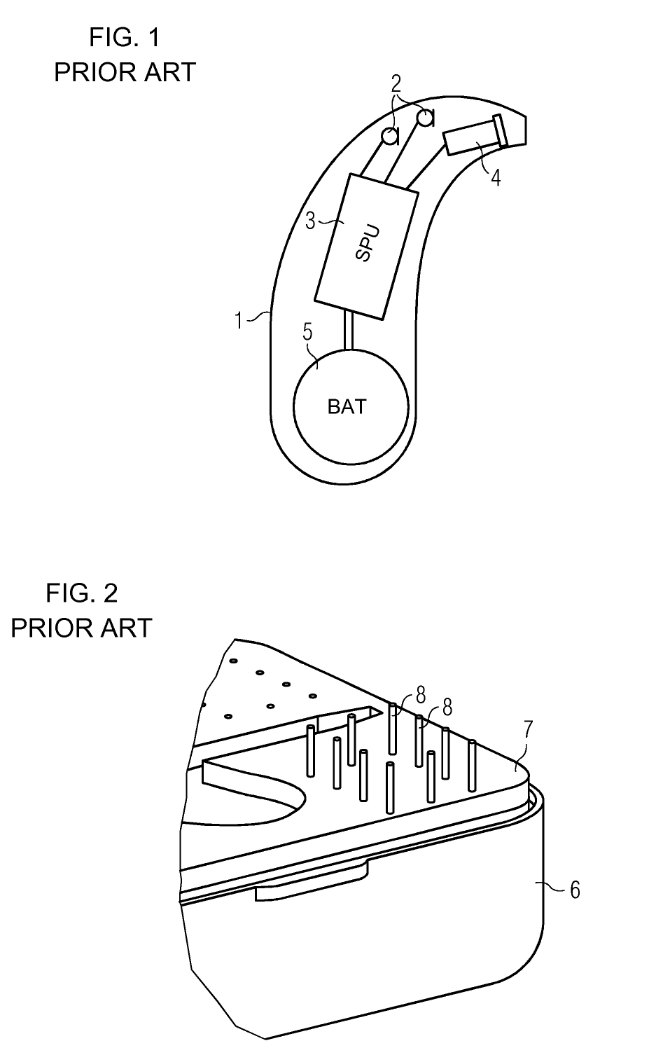

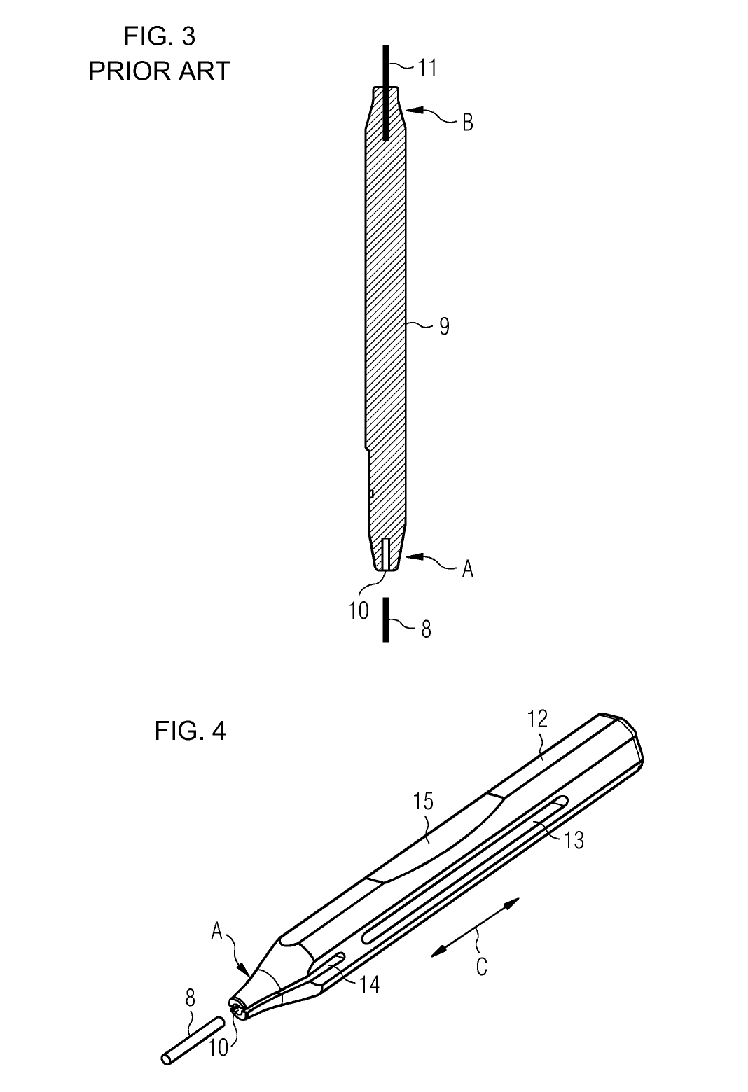

### DETAILED DESCRIPTION OF THE INVENTION

Referring now once more to the figures of the drawing in detail, FIG. 4 shows a perspective view of a gripper 12 according to the invention. At the front end A of the cylindrically embodied gripper 12, recessed into the gripper 12, is an aperture 10 by way of which a pin 8 can be picked up. Longitudinal slits 13 are formed along the longitudinal axis C of the gripper 12. The end zone A of the gripper 12 also is formed with slits 14.

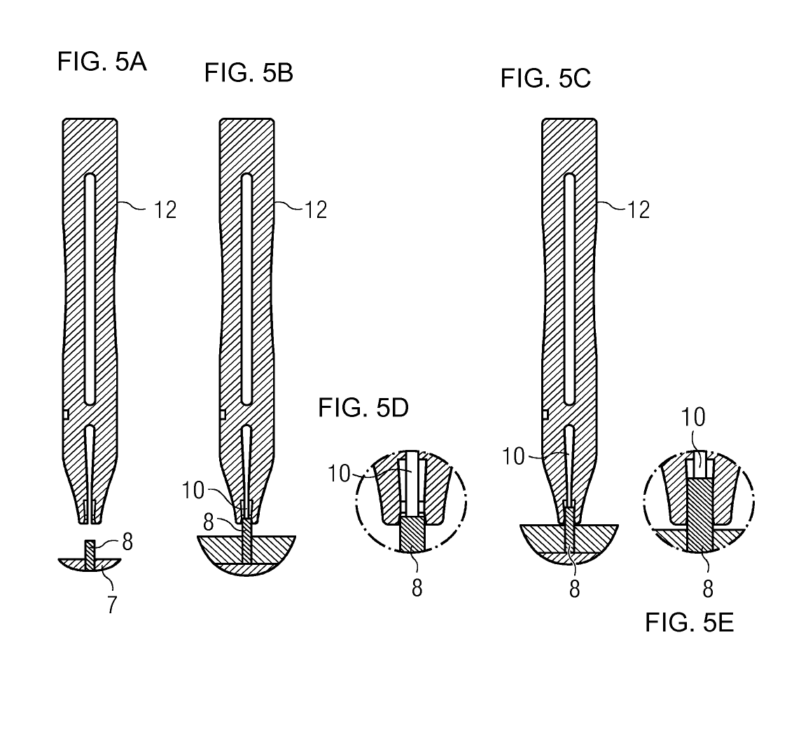

FIGS. 5A to 5E each show side views of the gripper 12 according to the invention in various states in the course of picking up a pin 8.

FIG. 5A shows a gripper 12 prior to picking up a pin 8. In the illustrated example the pin 8 is inserted in a foam padding 7, similar to a pin cushion.

FIG. 5B shows a pin 8 in the process of being picked up by a gripper 12. The gripper 12 is pressed onto a pin 8. Since the aperture 10 of the gripper 12 has a smaller diameter than the pin 8, the aperture 10 is spread apart and the pin 8 clamped into the aperture 10.

FIG. 5C again shows an aperture 10 that is being pressed onto a pin 8, this time in a magnified view.

FIG. 5D shows the state of a gripper 12 after completion of the action of picking up a pin 8. The pin 8 is clamped into the aperture 10 of the gripper 12 and can now be moved in a controlled manner in space together with the gripper 12.

FIG. 5E again shows the state of a gripper 12 after completion of the action of picking up a pin 8, this time in a magnified view.

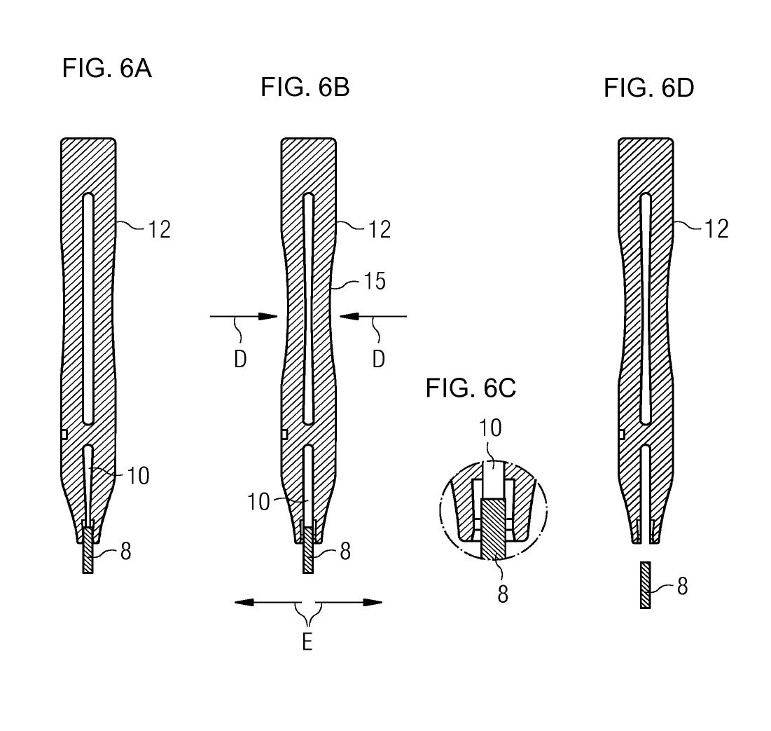

FIGS. 6A to 6D each show a side view of a gripper 12 according to the invention in various states in the course of a picked-up pin 8 being released.

FIG. 6A shows a pin 8 completely picked up in the aperture 10 of a gripper 12.

In the view shown in FIG. 6B a pressure force acts on the lateral surface 15 of the gripper 12 in the direction D. In other words, the gripper 12 is squeezed. This causes the size of the aperture 10 to change in the radial direction E, as a result of which the pin 8 that had been clasped by the gripper 12 is now released.

FIG. 6C shows a pin 8 which is located in an already slightly spread-apart aperture 10, in a magnified view.

FIG. 6D shows a pin 8 released by a gripper device 12.

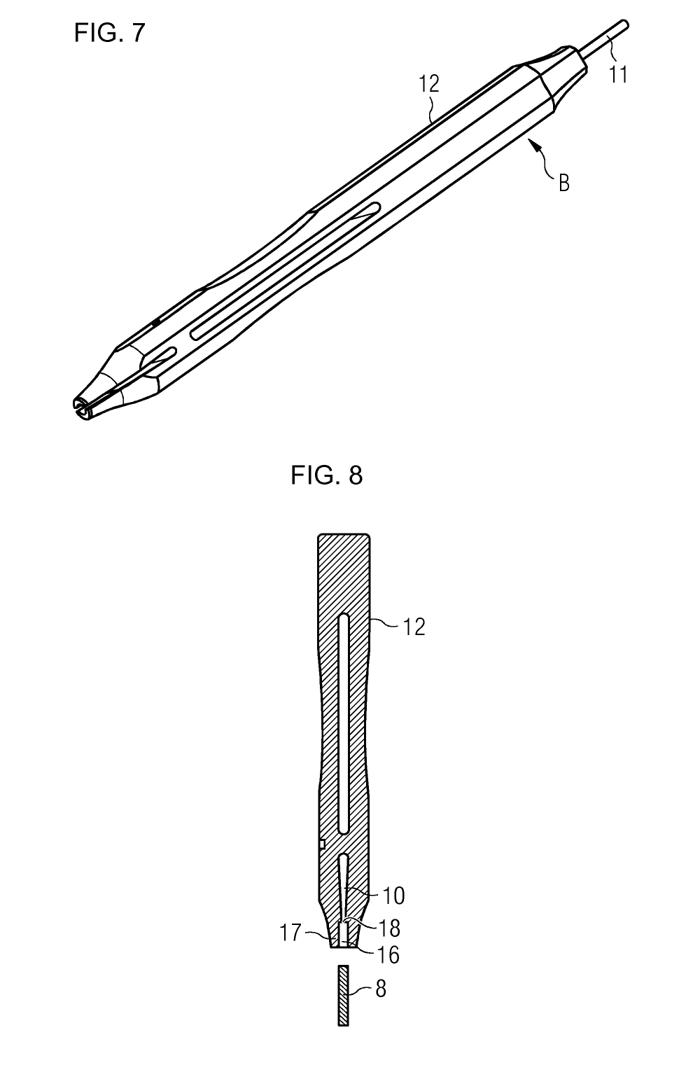

FIG. 7 shows a gripper 12 which includes an ejector pin 11 fixedly joined to the gripper 12 in the end zone B. The ejector pin 11 can be used to remove a pin in that the pin is pressed out of its mounting by way of the ejector pin 11.

FIG. 8 shows a gripper 12 according to the invention having an aperture 10 which consists of a first cylindrical section 16 and a second cylindrical section 17, both of which are disposed offset relative to each other. A pin 8 is picked up by way of the first cylindrical section 16 which has a greater depth stop surface area 18 in the picked-up state. The second cylindrical section 17 holds the pin in its position by means of pressure applied to the lateral surface of the pin.

1. A device for inserting a pin into a hearing aid, the device comprising:
a gripper having a substantially cylindrical shape with a lateral surface and an end face;
said end face having an aperture formed therein, wherein a size of said aperture in said end face of said gripper is changed by pressure acting on said lateral surface of said gripper.

2. The device according to claim 1, wherein said aperture has a circular cylindrical shape.

3. The device according to claim 2, wherein said aperture is formed with cylindrical sections that are offset relative to one another.

4. The device according to claim 1, wherein said end zone of said gripper is formed with a plurality of slits.

5. The device according to claim 1, wherein said aperture, in a first position thereof, has a diameter smaller than a diameter of the pin.

6. The device according to claim 1, wherein said aperture has a longitudinal axis extending parallel to a longitudinal axis of said gripper.

7. The device according to claim 1, wherein said gripper is formed of a single piece formed from an elastically deformable material.

8. The device according to claim 1, wherein said end zone of said gripper having said aperture is formed in a cone shape.

9. The device according to claim 1, wherein said lateral surface to be subjected to pressure force is formed with longitudinal slits extending along a longitudinal axis of said gripper.

10. The device according to claim 1, wherein said gripper has a front end opposite from said aperture in said end zone and wherein an ejector pin is fixedly joined to said front end of said gripper.
